(19) United States
(12) Patent Application Publication
(10) Pub. No.: US 2008/0105487 A1
(43) Pub. Date: May 8, 2008

(54) CURVED LOBE MIXER FOR A CONVERGING-STREAM NOZZLE FOR A TURBOMACHINE

(75) Inventors: Pierre Philippe Marie Loheac, Brie Comte-Robert (FR); Alexandre Alfred Gaston Vuillemin, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 11/764,454

(22) Filed: Jun. 18, 2007

(30) Foreign Application Priority Data
Jun. 19, 2006 (FR) 0652536

(51) Int. Cl. F02K 1/46; F01N 1/14; F02K 1/00

(52) U.S. Cl. 181/220; 239/265.11; 60/262

(57) ABSTRACT

The invention relates to a mixer for a bypass turbomachine, the mixer comprising a cylindrical member having a sinusoidal portion at its downstream end defining inner lobes and outer lobes distributed circumferentially, each outer lobe comprising a pair of radial walls interconnected by an outer curvilinear dome, each inner lobe comprising a pair of radial walls interconnected by an inner curvilinear dome, the walls of the outer lobes radially extending the walls of the inner lobes, the radial walls of the outer lobes and of the inner lobes presenting an outline that is substantially curved with at least one point of inflection.

### BACKGROUND OF THE INVENTION

The present invention relates to the general field of mixers for mixing concentric gas streams from a bypass turbomachine. The invention relates more particularly to a mixer of the daisy type for a converging-stream nozzle.

Sound pollution is nowadays one of the major concerns of engine manufacturers who are receiving more and more objections to the sound nuisance of their turbomachines. The sources of noise in a turbomachine are numerous, but that it has been found that the noise of the jet leaving the nozzle is the predominant noise during airplane takeoff. Certification authorities are becoming more and more strict in terms of noise emission from turbomachines, and manufacturers have been requested to make efforts to reduce the noise that turbomachines generate, and in particular the jet noise at the outlet from the nozzle.

Typically, a converging-stream nozzle of a turbomachine comprises a primary cover centered on the longitudinal axis of the turbomachine, a secondary cover disposed concentrically around the primary cover so as to define a first annular channel along which an outer stream (or cool stream) flows, and a central body disposed concentrically inside the primary cover so as to define a second annular channel along which an inner stream (or hot stream) flows, with the secondary cover extending beyond the primary cover.

Generally, a converging-stream nozzle also includes a mixer mounted at the downstream end of the primary cover. Such a mixer is designed to reduce jet noise at the outlet from the nozzle by forcing mixing to take place between the cool stream and the hot stream prior to their ejection. It is well known that such reductions in noise are obtained by increasing the degree of mixing between the cool stream and the hot stream coming from the turbomachine.

Amongst mixers for converging-stream nozzles, one particular known type of mixer is of the daisy type that is in the form of a substantially sinusoidal portion defining inner lobes and outer lobes distributed around the circumference of the primary cover of the nozzle. Reference can be made for example to U.S. Pat. Nos. 4,077,206 and 4,117,671.

With such a daisy type mixer, the inner lobes form gutters guiding the cool stream radially towards the second channel in which the hot stream flows, and the outer lobes form other gutters guiding the hot stream radially towards the first channel in which the cool stream flows. Thus, at the outlet from the mixer, the cool and hot streams mix in shear in a direction that is substantially radial. This mixing enables turbulence to be generated presenting an axis of rotation that is generally axial and of a magnitude that depends mainly on the stream ejection conditions (turbomachine bypass ratio, shear between the cool and hot streams) and on the conditions with which the bottoms of the lobes of the mixer are fed.

Unfortunately, when the ejection conditions of the streams and the feeding of the bottoms of the lobes are not optimized, the magnitude of the turbulence generated by a daisy type mixer is not sufficient for obtaining effective mixing between the cool stream and the hot stream, thus limiting the extent to which the jet noise levels can be reduced during airplane takeoff.

### OBJECT AND SUMMARY OF THE INVENTION

A main object of the present invention is thus to mitigate such drawbacks by proposing a daisy-petal type mixer that enables mixing between the cool stream and the hot stream to be improved so as to reduce the noise nuisance of the turbomachine.

This object is achieved by a mixer for mixing concentric inner and outer gas streams in a bypass turbomachine, the mixer comprising a substantially cylindrical member having a substantially sinusoidal portion at its downstream end defining inner lobes and outer lobes distributed circumferentially, each outer lobe comprising a pair of radial walls interconnected by an outer curvilinear dome so as to form an outer gutter guiding the inner gas stream to flow radially outwards, each inner lobe comprising a pair of radial walls interconnected by an inner curvilinear dome so as to form an inner gutter guiding the outer gas stream to flow radially inwards, the walls of the outer lobes being disposed to extend radially the walls of the inner lobes, and in which, in accordance with the invention, the radial walls of the outer lobes and of the inner lobes present an outline that is substantially curved with at least one point of inflection.

The use of radial walls having a curved outline with at least one point of inflection serves to create mixing between these streams in a direction that is substantially circumferential. Creating such azimuth mixing serves to reinforce the aerodynamic characteristics of the turbulence generated by the radial shear between the streams, and thus serves significantly to reduce the noise level of the nozzle jet regardless of the conditions under which the streams are ejected and with which the bottoms of the lobes are fed.

The points of inflection of the curved outline of the radial walls of the lobes may be situated radially at substantially equal distances from the outer domes and the inner domes of said respective lobes.

The respective tangents of the points of inflection of the curved outline of the radial walls of the lobes form respective angles with a radial plane containing both the point of inflection in question and the axis of symmetry of the cylindrical member, which angles are preferably greater than 0° and less than or equal to 45°.

Each lobe of the mixer may be symmetrical about a radial midplane of the lobe in question.

The invention also provides a turbomachine converging-stream nozzle that includes a mixer as defined above.

The invention also provides a turbomachine including a converging-stream nozzle fitted with a mixer as defined above.

### BRIEF DESCRIPTION OF THE DRAWINGS

Other characteristics and advantages of the present invention appear from the following description given with reference to the accompanying drawings that show an embodiment having no limiting character. In the figures:

FIG. 1 is a diagrammatic cutaway perspective view of a nozzle having converging streams fitted with a mixer of the invention;

FIG. 2 is a section view of FIG. 1 on a radial plane perpendicular to the longitudinal axis of the nozzle; and

FIG. 3 is an enlarged view of the lobes of the mixer in the section view of FIG. 2.

### DETAILED DESCRIPTION OF AN EMBODIMENT

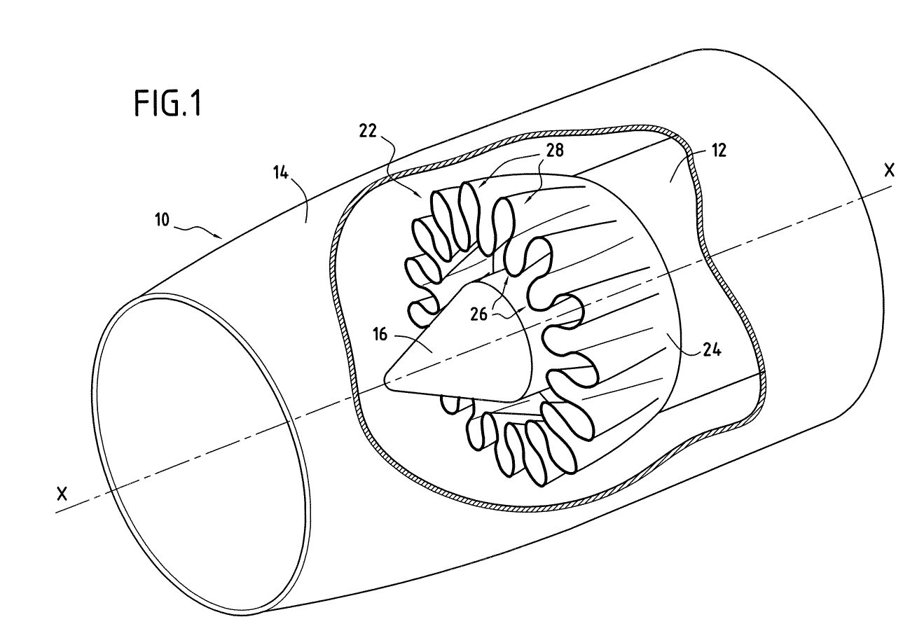

FIG. 1 is a cutaway diagrammatic perspective view of a nozzle 10 having converging streams in a bypass turbomachine.

The nozzle 10 is axially symmetrical in shape about its longitudinal axis X-X and is typically formed by a primary cover 12, a secondary cover 14, and a central body 16 all centered on the longitudinal axis X-X of the nozzle.

The primary cover 12 of substantially cylindrical shape extends along the longitudinal axis X-X of the nozzle. The central body 16 is disposed concentrically inside the primary cover and is terminated by a substantially conical portion.

The secondary cover 14, also substantially cylindrical in shape, surrounds the primary cover 12, being concentric thereabout and likewise extending along the longitudinal axis X-X of the nozzle. The secondary cover 14 extends longitudinally downstream beyond the primary cover 12.

It should be observed that in the embodiment shown in FIG. 1, the central body 16 of the nozzle 10 is of the external type, i.e. the central body extends longitudinally beyond the trailing edge of the primary cover 12.

Nevertheless, the invention can also apply to a nozzle for converging streams of the internal type in which the trailing edge of the primary cover extends longitudinally between the central body so as to cover it completely.

In the description below, the terms “inner” and “outer” designate an element of the mixer or of the nozzle that is respectively close to or far from the longitudinal axis X-X of the nozzle.

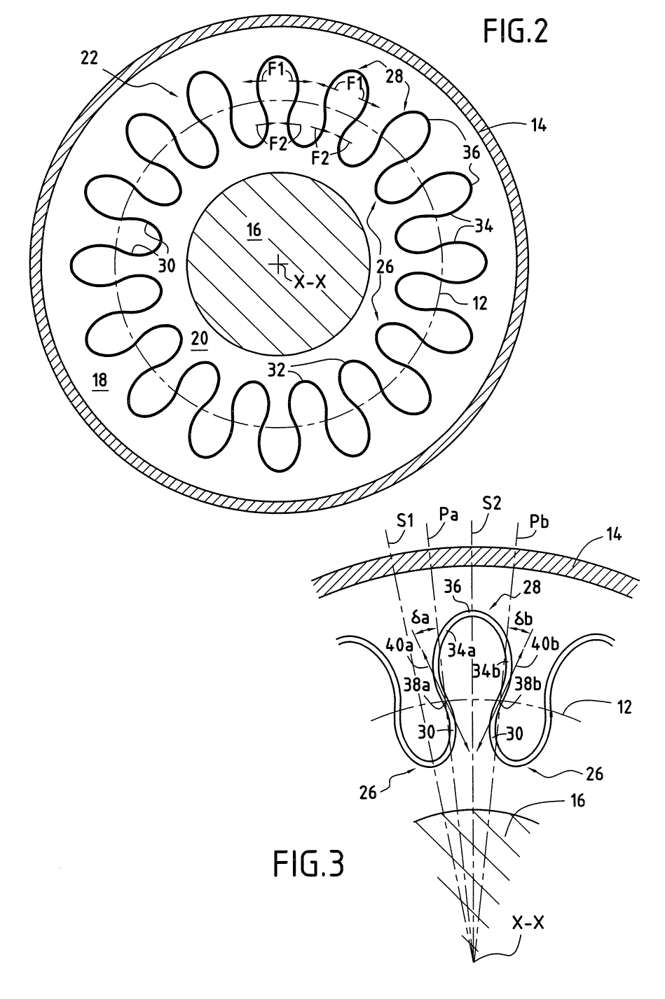

As shown in FIG. 2, the concentric assembly of the elements of the nozzle 10 serves to define firstly a first annular channel 18 between the primary and secondary covers 12 and 14 for passing an outer stream of gas coming from the turbomachine and referred to as the bypass stream or the cool stream, and secondly between the primary cover 12 and the central body 16, a second annular channel 20 for passing an inner stream of gas coming from the turbomachine and referred to as the main stream or hot stream.

The main and bypass streams traveling along these two annular channels 18 and 20 mix together in a mixer 22 located at the downstream end of the primary cover 12.

The mixer 22 of the invention is of the daisy type. It comprises a member 24 that is substantially cylindrical with its downstream end presenting a substantially sinusoidal portion defining inner lobes 26 and outer lobes 28.

The inner and outer lobes 26 and 28 of the mixer alternate relative to one another and may be regularly distributed around the entire circumference of the cylindrical member 24.

As shown in FIG. 2, the inner lobes 26 project radially towards the inside of the primary cover 12, i.e. they penetrate into the second channel 20 for passing the hot stream, while the outer lobes 28 project radially outwards from the primary cover 12, i.e. they penetrate into the first channel 18 for passing the cool stream.

Furthermore, as shown in FIG. 1, the lobes 26 and 28 of the mixer all extend over the same longitudinal distance. Nevertheless, the invention also applies to mixers in which the lobes present different lengths in the longitudinal direction.

More precisely, each inner lobe 26 is formed by a pair of walls 30 extending in a radial direction, which walls are spaced apart from each another in the circumferential direction and are interconnected on the inside by an inner curvilinear dome (or arch) 32.

In the same manner, each outer lobe 28 is formed by a pair of walls 34 (also referenced 34a, 34b in the description) that extend in a substantially radial directions, which walls are spaced apart from each another in the circumferential direction and are interconnected on the outside by an outer curvilinear dome 36.

It should be observed that the radial walls 34 of a given outer lobe 28 are disposed radially extending the radial walls 30 of two inner lobes 26 that are directly adjacent thereto (and vice versa).

Thus, each inner lobe 26 forms an inner gutter (or trough) enabling the cool stream flowing in the first channel 18 of the nozzle to be guided to flow inwards, i.e. enabling the cool stream traveling along such inner gutters to be directed radially towards the longitudinal axis X-X of the nozzle to mix with the hot stream flowing in the second channel 20 of the nozzle.

Similarly, each outer lobe 28 forms an outer gutter (or trough) enabling the hot stream flowing in the second channel 20 of the nozzle to be guided to flow radially outwards, i.e. the hot stream travels along such outer gutters and is directed towards the first channel 18 of the nozzle to be mixed with the cool stream flowing therein.

As a result, mixing takes place between the cool stream flowing in the first channel 18 and the hot stream flowing in the second channel 20. This mixing, which serves in particular to reduce the jet noise from the nozzle, takes place in a direction that is generally radial. This is due to the particular shape of the mixer with its lobes that penetrate radially into the respective flow channels for the cold and hot streams.

In the invention, each radial wall 30, 34 of the inner and outer lobes 26 and 28 present an outline that is substantially curved and that includes at least one point of inflection.

This characteristic can be seen particularly clearly in FIGS. 2 and 3 which show the mixer 22 in section view on a radial plane perpendicular to the longitudinal axis X-X of the nozzle.

In FIG. 3, if an outer lobe 28 and one of the two inner lobes 26 adjacent thereto are taken by way of example, it can clearly be seen that the radial walls 34a, 30 of these lobes which are situated radially one after the other present an outline of curved shape with a point of inflection 38a.

Starting from the same outer lobe 28, it can also be seen that its other radial wall 34b and the radial wall 30 of the other inner lobe 26 that is adjacent thereto (these walls 30 and 34b extending each other) also present an outline of curved shape with a point of inflection 38b.

The term “point of inflection” 38a, 38b is used to designate a regular point of the outline of the radial walls of the inner and outer lobes where said outline crosses its own tangent 40a, 40b.

The points of inflection 38a, 38b of the curved outline of the radial walls of the lobes may be situated radially at substantially equal distances from the outer and inner domes 36 and 32 of the respective outer and inner lobes 28 and 36.

Furthermore, these points of inflection 38a, 38b may be situated to extend longitudinally the downstream end of the primary cover 12 of the nozzle. As a result of these dispositions, the radial penetration of the inner lobes 26 into the hot stream is substantially identical to the radial penetration of the outer lobes 28 into the cool stream.

The respective tangents 40a, 40b at the points of inflection 38a, 38b of the radial walls of the lobes 26, 28 form respective angles δa, δb with a radial plane Pa, Pb containing both the point of inflection concerned and the axis of symmetry of the cylindrical member 24 of the mixer (which axis coincides with the longitudinal axis X-X of the nozzle). This angle δa, δb is preferably greater than 0° and less than or equal to 45°.

As shown in FIG. 3, each lobe 26, 28 of the mixer may be symmetrical relative to a radial midplane of the corresponding lobe (although an asymmetrical disposition could also be envisaged).

Thus, in the example of FIG. 3, each inner lobe 26 is symmetrical about a radial midplane S1 of the lobe, and each outer lobe 28 is symmetrical about a radial midplane S2 of the lobe.

A result of such particular symmetry of the lobes 26 and 28 is that the outlines of the radial walls of any given lobe are symmetrical about the corresponding midplane S1, S2, and the angles δa, δb formed by the respective tangents 40a, 40b at the points of inflection 38a, 38b are identical (in absolute value).

The profile of each radial wall 30 of an inner lobe 26 thus bulges in an essentially circumferential direction towards the inner stream flowing in the first channel 18 of the nozzle. Similarly, the profile of each radial wall 34 of the outer lobes 28 bulges in an essentially circumferential direction towards the outer stream flowing in the second channel 20 of the nozzle.

The bulging profiles of the radial walls of the lobes serve to create mixing in a substantially circumferential direction between the hot stream and the cool stream.

As shown in FIG. 2, the profiles of the radial walls of each outer lobe 28 generate a flow in a circumferential direction of the hot stream traveling in the outer gutter defined by said outer lobe. This circumferential flow (or azimuth flow) is represented by arrows F1 in FIG. 2. For each outer lobe, it is directed towards the two outer lobes that are adjacent thereto.

Similarly, the profile of the radial walls of each inner lobe 26 generates a flow in a circumferential direction of the cool stream traveling in the inner gutter defined by said inner lobe. This circumferential (or azimuth) flow is represented by arrows F2. It is in the direction opposite to that generated by the radial walls of the outer lobes 28, i.e. for each inner lobe it is directed towards the two inner lobes that are adjacent thereto.

Naturally, the azimuth flows F1 and F2 are additional to the main flows of the gas stream traveling radially in the outer and inner gutters defined respectively by the outer and inner lobes of the mixer.

Thus, the cool stream flowing in the first channel 18 of the nozzle is guided mainly in a radially-inward direction while following the inner lobes 26, and at the downstream ends of said lobes, a portion of this stream is directed in a circumferential direction into the hot stream by the bulging outline of the radial walls of the lobes. In addition, the hot stream flowing in the second channel 18 of the nozzle is guided mainly in a radially-outward direction while following the outer lobes 28, and at the downstream ends of said lobes, a portion of this stream is directed in a circumferential direction into the cool stream by the bulging outline of the radial walls of the lobes.

As a result, the main shear between the cool and the hot streams that occurs in a direction that is generally radial, has associated therewith an additional or secondary shear between these two streams that occurs in a circumferential direction and serves to intensify mixing between the streams, and consequently serves to improve the acoustic efficiency of the device.

It should be observed that the greater the angles δa, δb formed by the respective tangents 40a, 40b at the points of inflection 38a, 38b of the radial walls of the lobes, the greater the quantity of circumferential mixing between the cool stream and the hot stream.

What is claimed is:

1. A mixer for mixing concentric inner and outer gas streams in a bypass turbomachine, the mixer comprising a substantially cylindrical member having a substantially sinusoidal portion at its downstream end defining inner lobes and outer lobes distributed circumferentially, each outer lobe comprising a pair of radial walls interconnected by an outer curvilinear dome so as to form an outer gutter guiding the inner gas stream to flow radially outwards, each inner lobe comprising a pair of radial walls interconnected by an inner curvilinear dome so as to form an inner gutter guiding the outer gas stream to flow radially inwards, the walls of the outer lobes being disposed to extend radially the walls of the inner lobes, wherein the radial walls of the outer lobes and of the inner lobes present an outline that is substantially curved with at least one point of inflection.

2. A mixer according to claim 1, in which the points of inflection of the curved outline of the radial walls of the lobes are situated radially at substantially equal distances from the outer domes and the inner domes of said respective lobes.

3. A mixer according to claim 1, in which the respective tangents of the points of inflection of the curved outline of the radial walls of the lobes form respective angles with a radial plane containing both the point of inflection in question and the axis of symmetry of the cylindrical member, which angles are greater than 0° and less than or equal to 45°.

4. A mixer according to claim 1, in which each lobe is symmetrical relative to a radial midplane of the lobe in question.

5. A converging-stream nozzle for a turbomachine, the nozzle including a mixer according to claim 1.

6. A turbomachine including a converging-stream nozzle fitted with a mixer according to claim 1.
